(19) United States
(12) Patent Application Publication
(10) Pub. No.: US 2006/0280319 A1
(43) Pub. Date: Dec. 14, 2006

(54) Micromachined Capacitive Microphone

(75) Inventors: Yunlong Wang, Fremont, CA (US); Erhan Ata, San Diego, CA (US); Guanghua Wu, Dublin, CA (US)

Correspondence Address: GENERAL MEMS CORPORATION, 47667 GRIDLEY COURT, FREMONT, CA, 94539, US

(73) Assignee: GENERAL MEMS CORPORATION, Sunnyvale, CA (US)

(21) Appl. No.: 11/160,071

(22) Filed: Jun. 8, 2005

(51) Int. Cl. H04R 25/00

(52) U.S. Cl. 381/172

(57) ABSTRACT

This invention relates to a micromachined capacitive microphone having a shallowly corrugated diaphragm that is anchored at one or more locations on the support has a plurality of dimples to support itself and rest freely on the perforated backplate. The diaphragm whose ends are not anchored is bounded by the taps of edge rail. Also disclosed includes: a fixed perforated backplate having one or more regions; an adjustable cantilever formed by the diaphragm, the support and the backplate; a plurality of dimples maintaining vertical separation between diaphragm and backplate; and the patterning of conductor electrodes carried by diaphragm and backplate.

### CROSS REFERENCE TO RELATED APPLICATION

U.S. Pat. Nos. 5,146,435; 5,452,268; 6,535,460; 6,847,090; 6,870,937.

### BACKGROUND OF THE INVENTION

Micromachined capacitive microphone has been an attractive topic for many publications and disclosures. The batch processing of micromachining enables the production of these microphones to be made inexpensively and in large quantity. Compared with traditional capacitive microphones, micromachined capacitive microphones offer a much larger set of parameters for optimization as well as ease for on-chip electronic integration.

In many publications such as U.S. Pat. Nos. 5,146,435; 5,452,268; 6,847,090; and 6,870,937, the movable diaphragm of a micromachined capacitive microphone is either supported by a substrate or insulative supports such as silicon nitride, silicon oxide and polyimide. The supports engage the edge of the diaphragm, and a voltage is applied between the substrate and the surface of the diaphragm causing the diaphragm to be biased and vibrate in response to the passing sound waves. In one particular case as described in the U.S. Pat. No. 6,535,460, the diaphragm is suspended to allow it rest freely on the support rings.

A good microphone is considered to have a nearly flat frequency response across the audio range that it operates, that is, from 20 Hz to 20 kHz. It also needs to have high sensitivity which means the diaphragm will need to be very compliant. However, achieving a large dynamic range and a high sensitivity can be conflicting goals, since large sound pressures may cause a diaphragm to collapse under its voltage bias if it is very compliant. For micromachined capacitive microphones, the sensitivity is mainly affected by the intrinsic stress in the diaphragm given the size and thickness of diaphragm are fixed. Since intrinsic stress is resulted from the process, the stress releasing and control technique is vital in achieving good micromachined capacitive microphones.

One commonly used stress releasing technique is to form corrugations in the diaphragm. The corrugated diaphragm is capable of releasing the built-in stress during the processing, thereby increasing the mechanical sensitivity of the diaphragm and reducing the irreproducibility. Compared with the conventional flat diaphragm, the corrugated diaphragm has an increased sensitivity, especially for the case of high residual stress level. FIG. 1 shows the corrugation structure that is typically used for making micromachined microphones. The diaphragm 2 has a corrugation 3, and is anchored on the backplate 1 to form an air gap 6. When acoustic wave 7 is impinged upon the diaphragm 2, it vibrates relative to the backplate 1, generating electrical signal output. In this structure, anchor position 5 is the stress concentration point. Its stress value is usually many times of the intrinsic stress in the diaphragm 2. When the intrinsic stress in the diaphragm 2 is large, the stress at anchor position 5 can be very high to cause it to break, resulting in microphone failure and other reliability issues.

In micromachining, residual stress is inevitable in deposited films such as silicon nitride, polysilicon, and polyimide. And therefore, it is of vital importance to develop a technique to release residual stress in the diaphragm film while maintaining its mechanical strength.

### OBJECTS AND SUMMARY OF THE INVENTION

It is an object of the present invention to provide a micromachined capacitive microphone having wide and flat frequency response and high sensitivity.

It is a further object of the present invention to provide a micromachined capacitive microphone that comprises a perforated back plate supported on a substrate.

It is another object of the present invention to provide a micromachined capacitive microphone that has shallowly corrugated diaphragm.

It is a further object of the present invention to provide a micromachined capacitive microphone whose shallowly corrugated diaphragm is anchored at one or more locations on the support through its cantilever so formed by the diaphragm, the support and the backplate. The level of stress in the diaphragm is adjusted by changing the cantilever arm length, the support size and anchoring width.

It is another object of the present invention to provide a micromachined capacitive microphone whose diaphragm has dimples to maintain proper vertical separation from the backplate and to allow it rest freely on the backplate.

It is a further object of the present invention to provide a micromachined capacitive microphone whose diaphragm edges are not anchored is bounded by an edge rail and taps to restrict its lateral and vertical movements.

It is another object of the present invention to provide a micromachined capacitive microphone that has a path for equalizing barometric pressure.

It is a further object of the present invention to provide a micromachined capacitive microphone having wide operational bandwidth and high sensitivity is mechanically reliable.

It is another object of the present invention to provide a micromachined capacitive microphone that has the reduced parasitics.

The foregoing and other objects of the invention are achieved by a micromachined capacitive microphone including a perforated backplate supported on a substrate, a shallowly corrugated diaphragm that is suspended above the said backplate and the said suspended shallowly corrugated diaphragm is anchored on the said backplate at one or more locations through a cantilever structure so formed by the said diaphragm, the support and the backplate. The said suspended shallowly corrugated diaphragm has a plurality of dimples to maintain proper vertical separation from the said backplate and to allow it rest freely on the said backplate. The said diaphragm whose edges are not anchored is bounded by edge rails and taps to restrict its lateral and vertical movements. A relief path is formed by the tap of said edge rail, the through holes on the said backplate, and between the dimples under the diaphragm to equalize the barometric pressure. Each diaphragm is itself a conductor or supports a conductive electrode for movement therewith, whereby each perforated backplate forms a capacitor with the said diaphragm. The capacitance of the said capacitor varies with movement of the diaphragm in response to the passing acoustic wave. Conductive lines interconnect said conductive electrodes to provide output signals.

### BRIEF DESCRIPTION OF THE DRAWINGS

The foregoing and other objects of the invention will be more clearly understood from the following description when read in conjunction with the accompanying drawings of which:

FIG. 1 is a cross-sectional view of a micromachined capacitive microphone with corrugated diaphragm.

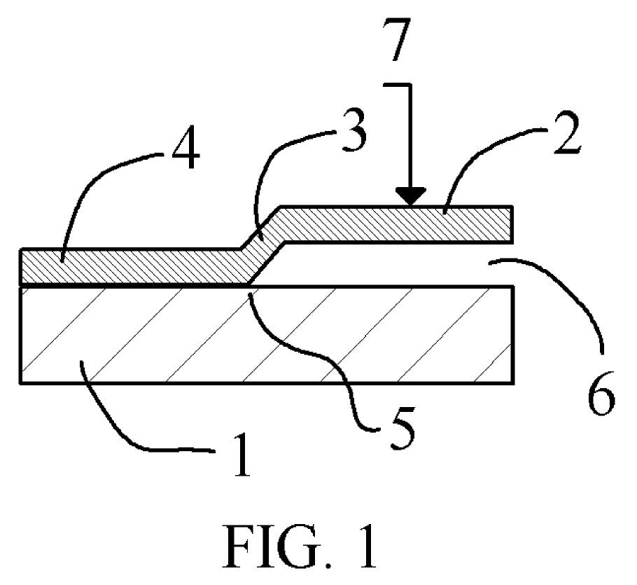

FIG. 2 shows a cross-sectional view of a micromachined capacitive microphone along the line A-A′ in FIG. 4 according to one preferred embodiment of the present invention.

FIG. 3 shows a cross-sectional view of a micromachined capacitive microphone along the line A-A′ in FIG. 5 according to another preferred embodiment of the present invention.

FIG. 4 shows a top plane view of a micromachined capacitive microphone according to one preferred embodiment of the present invention.

FIG. 5 shows a top plane view of a micromachined capacitive microphone according to another preferred embodiment of the present invention.

FIG. 6 shows a cross-sectional view of a micromachined capacitive microphone along the line A-A′ in FIG. 8 according to another preferred embodiment of the present invention.

FIG. 7 shows a cross-sectional view of a micromachined capacitive microphone along the line A-A′ in FIG. 9 according to a further preferred embodiment of the present invention.

FIG. 8 shows a top plane view of a micromachined capacitive microphone according to another preferred embodiment of the present invention.

FIG. 9 shows a top plane view of a micromachined capacitive microphone according to a further preferred embodiment of the present invention.

FIG. 10 is a top view of metal patterning of electrode on the diaphragm according to one preferred embodiment of the present invention.

FIG. 11 is a cross-sectional view of a micromachined capacitive microphone with metal patterning according to one preferred embodiment of the present invention.

FIG. 12 is a cross-sectional view of capacitive microphone with a composite diaphragm according to another preferred embodiment of the present invention.

### DESCRIPTION OF THE PREFFERRED EMBODIMENTS

For micromachined capacitive microphones, its sensitivity is largely dominated by the intrinsic stress of diaphragm. When the size of the diaphragm is fixed, its mechanical sensitivity is inversely proportional to the intrinsic stress in the diaphragm. A diaphragm has the highest mechanical sensitivity when it is free to move in a plane that is perpendicular to its own plane as a piston. On the other hand, certain level of intrinsic stress needs to be maintained in the diaphragm such that its resonant frequency is far from the frequency range it operates, thereby exhibiting a flat frequency response in the audio frequency range. In addition, the mechanical strength of the diaphragm also requires the diaphragm to be stiffer. These seemed conflicting requirements suggest that a micromachined capacitive microphone needs to have ways to tightly control its intrinsic stress to meet the final product requirements. One technique to release or control the intrinsic stress in the diaphragm is to develop a costly micromachining recipe. But such technique suffers from transportability between different foundries as they tend to have different capabilities.

The bandwidth of a microphone also depends on the lower cut-off frequency. The lower cut-off frequency is caused by the air in a confined cavity. For instance, the narrow air-gap between diaphragm and backplate, and back chamber. A pressure equalization vent is needed to equalize very slow variations in atmospheric pressure (low frequencies) to prevent the diaphragm from snap down to the backplate. Therefore, a low-frequency mechanical roll-off in the membrane response is resulted. The equalization vent prevents many micromachined microphones from sensing below 100 Hz. To keep the low frequency cut-off as low as possible the size and shape of the static pressure equalization vent and acoustic holes must be carefully designed.

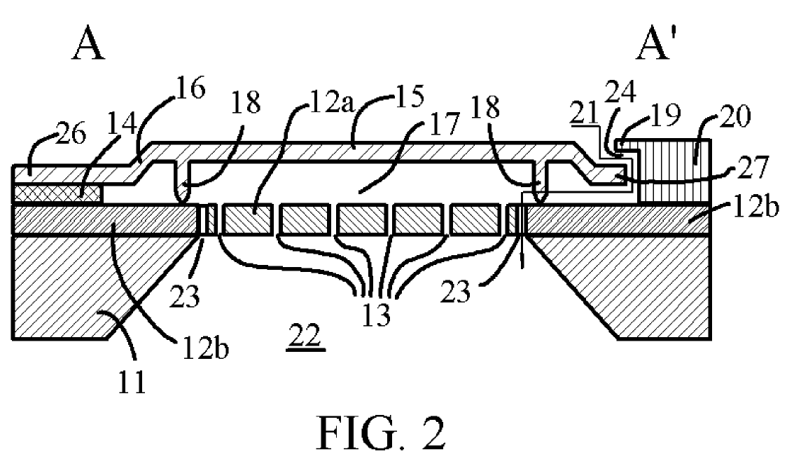

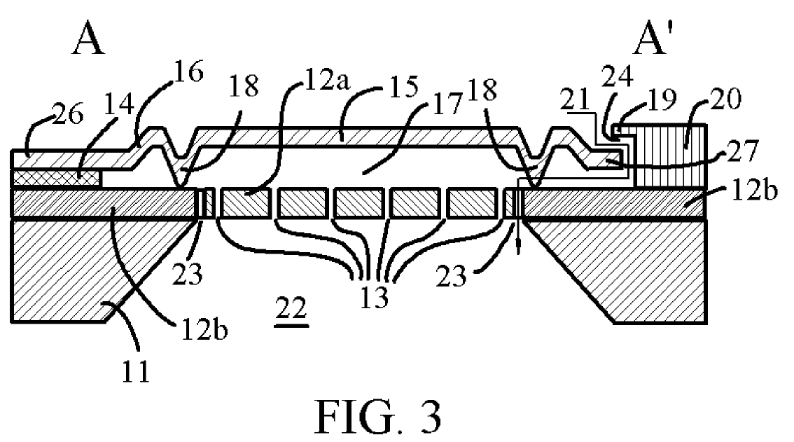

We therefore consider different approaches to release and control the stress in the diaphragm, and to form pressure equalization vents. Our approach to release the intrinsic stress is to form shallow corrugation, and to anchor the diaphragm through cantilever structures. Both diaphragm and backplate can be made of conductive material or non-conductive materials. According to the first embodiment of present invention, the diaphragm 15 is made of a conductive material. Referring to FIG. 2, the backplate 12 has a conductive region 12a and a non-conductive region 12b, and is supported by a substrate 11. There are perforation holes 13 on the conductive region 12a of backplate 12 to allow the passage of air trapped in the air gap 17 between diaphragm 15 and conductive region 12a of backplate 12. The conductive region 12a and non-conductive region 12b of the backplate 12 are disconnected such that the motion of the conductive region 12a of back 12 is not coupled into the vibrations of diaphragm 15 in response to passing acoustic sound. Diaphragm 15 is shallowly corrugated with corrugation 16, and is anchored at one end 26 on a support 14, which itself is supported by a non-conductive region 12b of the backplate 12. The other end of diaphragm 15 is simply supported by dimples 18 to rest freely on the non-conductive region 12b of backplate 12. At this end, the edge 27 of diaphragm 15 is loose and bounded by the edge rail 20 in lateral movement, and its upper ward movement is limited by tap 19. Dimples 18 also define the separation between the diaphragm 15 and the backplate 12. The shape of dimples 18 can be as T-shaped as shown in FIG. 2, or V-shaped as shown in FIG. 3 according to second preferred embodiment of present invention.

The backplate 12 also has through holes 23 to equalize the barometric pressure inside the back chamber 22. The air release path 21 consists of the gap 24 formed between tap 19 and edge 27 of diaphragm 15, under the diaphragm 15 and between dimples 18, and through air holes 23. By adjusting the clearance of air gap 24, the level of air tightness can be adjusted. This controls the lower cut-off frequency of the micromachined capacitive microphone. The acoustic resistance can also be manipulated by adjusting the length of tap 19 and the length of edge 27 to vary the overlap, thereby increasing or decreasing the resistance for acoustic signal passing through the air release path 21, and eventually further controls the low frequency response of the micromachined capacitive microphone.

The anchoring region 26 of diaphragm 15, the corrugation region 16 of diaphragm 15 and support 14 form a cantilever structure where the compliance of the diaphragm 15 can be adjusted by changing the lateral size of support 14, which in effect changes the cantilever arm length. In doing so, it also controls the stress in the diaphragm 15, and hence the mechanical sensitivity of micromachined capacitive microphone.

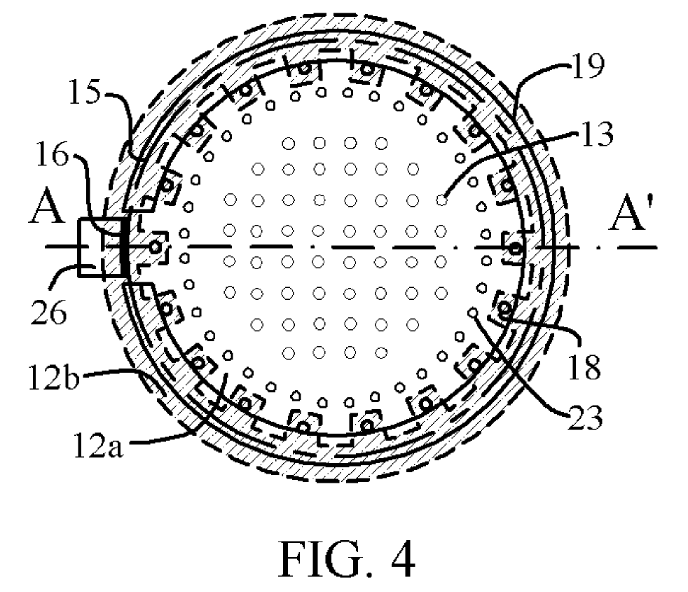

Referring to FIG. 4. This is a top plane view of a micromachined capacitive microphone according to the first and second preferred embodiments of present invention. The backplate 12 has a conductive region 12a, and a non-conductive region 12b that is shaded in FIG. 4. Since the diaphragm 15 is made of conductive material, its dimples 18 need to rest on the non-conductive region 12b of the backplate 12 to make them electrically isolated. The patterning of backplate 12 can have different forms, and the size of support for the dimples 18 on the non-conductive region 12b of backplate 12 can also be large or small depending on the photolithography process capabilities for forming the dimples 18. The backplate 12 is patterned only for the size of active region of diaphragm 15. Such patterning also helps reduce the parasitics of the micromachined capacitive microphone.

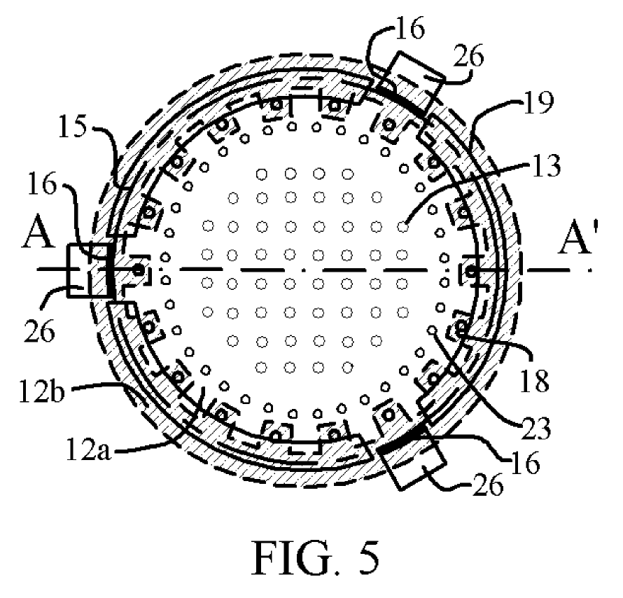

To further adjust the compliance or stiffness in the diaphragm 15, the width of the anchoring end 26 of diaphragm 15 can be changed to meet the required needs. According to third preferred embodiment of present invention, it is also possible to increase the number of anchoring positions to control the level of stiffness in the diaphragm 15 and hence the overall mechanical sensitivity. As an example, FIG. 5 shows the diaphragm 15 is anchored at three anchoring positions according to third preferred embodiment of present invention.

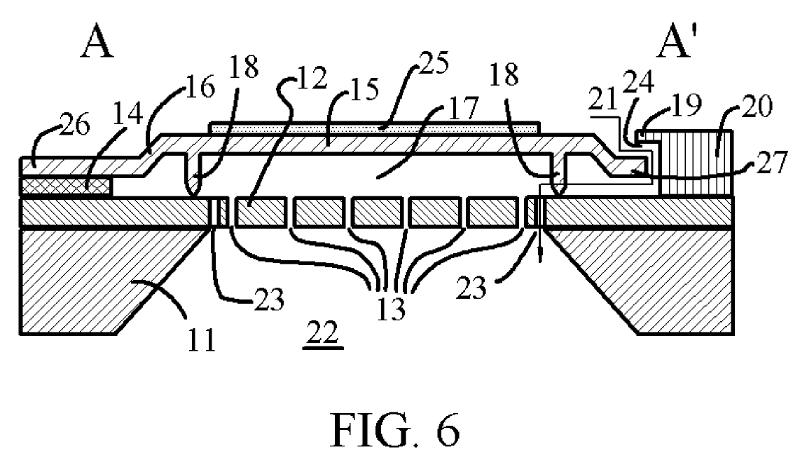

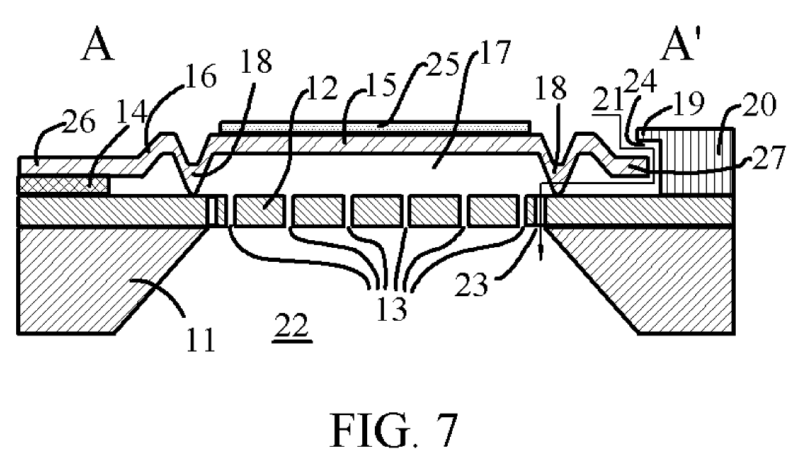

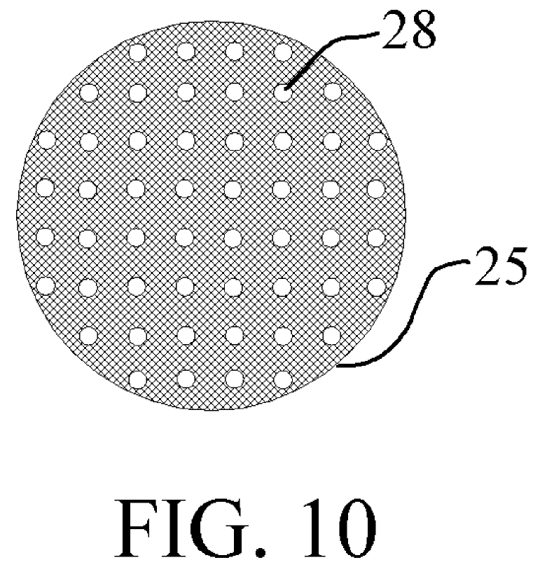

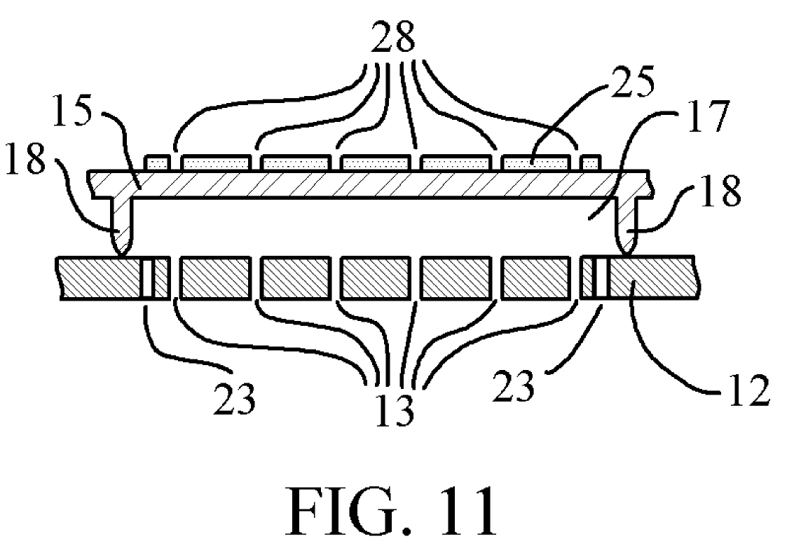

According to fourth preferred embodiment of present invention, the diaphragm 15 can also be made with non-conductive micromachining thin films. Referring to FIG. 6. The perforated backplate 12, which is a complete layer of conductive material, is supported by a substrate 11. When the diaphragm 15 is made of non-conductive material such as Silicon Nitride, a layer of thin film metal 25 is deposited on the diaphragm 15 to make it a capacitor with the backplate 12. The metal layer 25 is patterned, as shown in FIG. 10, to reduce the parasitics. The voids 28 are made to be about the same size of perforation holes 13 on the backplate 12, and are lined up with perforation holes 13, as shown in FIG. 11. FIG. 7 shows a cross-sectional view of a micromachined capacitive microphone according to fifth preferred embodiment of present invention, where the dimples 18 are V-shaped.

According to sixth and seventh preferred embodiments of present invention, when the diaphragm 15 is made with non-conductive micromachining thin films, the backplate 12 can also be made of a conductive region 12a and a non-conductive region 12b, and can be similarly patterned as shown in FIGS. 4 and 5. In these preferred embodiments, the diaphragm 15 is anchored at one or more positions to the non-conductive region 12b of backplate 12 through support 14.

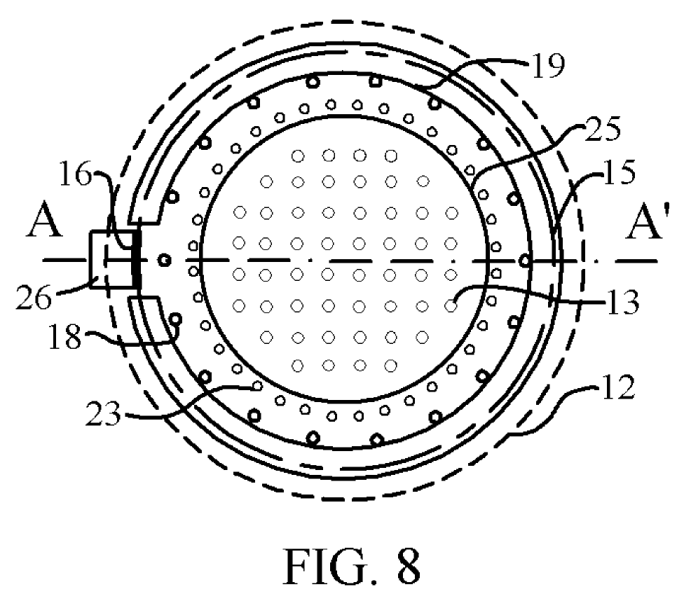

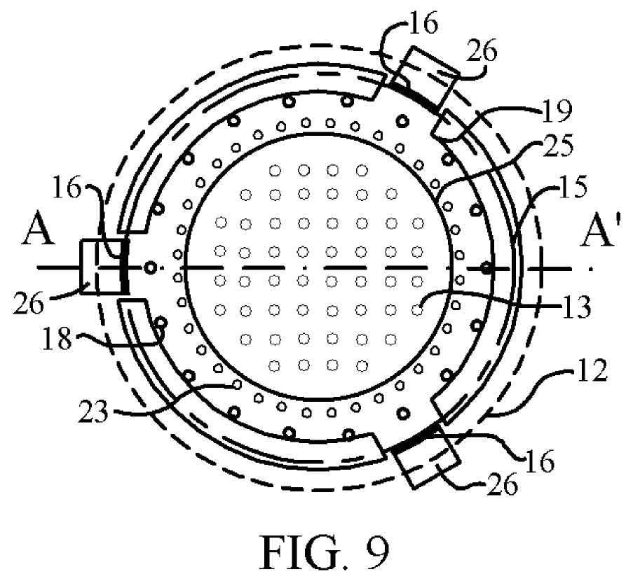

FIG. 8 is a top plane view of a micromachined capacitive microphone according to fourth preferred embodiment of present invention. In this embodiment, the backplate 12 is made of a complete layer of conductive material. The diaphragm 15 is made of a non-conductive material. Metal layer 25 is deposited at the center portion of the diaphragm 15. Voids 28 on the metal layer 25 are patterned at the same lateral locations as perforation holes 13 on the backplate 12. Similarly to other preferred embodiments of present invention, the width of the anchoring end 26 of diaphragm 15 can be changed to adjust the stress and hence the compliance in the diaphragm 15. It is also possible to increase the number of anchoring positions, according to other preferred embodiments of present invention. FIG. 9 shows the diaphragm 15 is anchored at three anchoring positions according to fourth preferred embodiment of present invention.

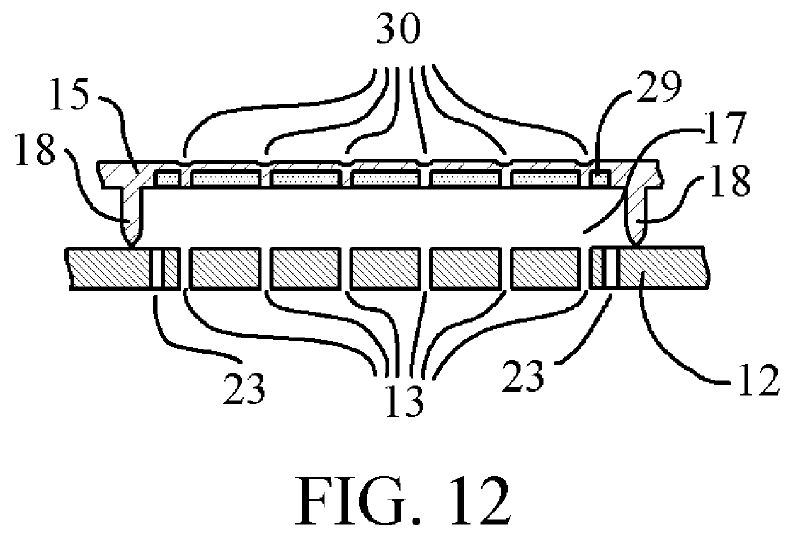

According to eighth preferred embodiment of present invention, the diaphragm 15 can also be made of a conductive film 29 and a non-conductive layer 30. FIG. 12 shows the cross-sectional view of the micromachined capacitive microphone according to eighth preferred embodiment of present invention. The conductive film 29 is first deposited and patterned to reduce parasitics. A non-conductive layer 30 is then deposited on top of conductive film 29 to form the diaphragm 15.

The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A micromachined capacitive microphone including
a shallowly corrugated diaphragm having a plurality of support dimples connected to the diaphragm is anchored at one or more locations on the support;
a remaining diaphragm layer that is loose at other locations is bounded at perimeters by edge rail and tap for lateral and vertical movements and forms a passage at these locations with the tap on edge rail;
a perforated backplate having perforation holes and through holes is spaced in parallel below the diaphragm; and
the said diaphragm, the said support and the said backplate form a cantilever structure that is shaped to release and control the stress in the said diaphragm.

2. A micromachined capacitive microphone as in claim 1 in which the said diaphragm is anchored at one or more locations on the said support. Adjusting the number of anchoring positions, the said cantilever arm length, the support size and anchoring width of said anchors releases and controls the stress level in the said diaphragm.

3. A micromachined capacitive microphone as in claim 1 in which the said diaphragm has a plurality of support dimples that define the separation of the said diaphragm from the said perforated backplate.

4. A micromachined capacitive microphone as in claim 1 in which the said diaphragm having a plurality of support dimples rests freely on the said backplate and is simply supported on the said backplate by the said dimples.

5. A micromachined capacitive microphone as in claim 1 in which the said diaphragm is loosely supported by the said substrate at positions where the said diaphragm is not anchored onto the said support, and is bounded by the said edge rail and said tap for lateral and vertical movements.

6. A micromachined capacitive microphone as in claim 1 in which the said backplate is conductive, has one conductive region and one non-conductive region. The dimples of said diaphragm are rested on the conductive region, and non-conductive region.

7. A micromachined capacitive microphone as in claim 1 in which the said diaphragm is made of a conductive film material, a non-conductive film and a conductive metal as electrode, and a composite of conductive and non-conductive films.

8. A micromachined capacitive microphone including
a shallowly corrugated diaphragm having a plurality of support dimples connected to the diaphragm is anchored at one or more locations on the support;
a remaining diaphragm layer that is loose at other locations is bounded at perimeters by edge rail and tap for lateral and vertical movements and forms a passage at these locations with the tap on edge rail;
a perforated backplate having perforation holes and through holes is spaced in parallel below the diaphragm; and
the said diaphragm, the said tap on edge rail, and the said perforated backplate having pre-defined through holes forms a low-pass filter for passage of slow varying ambient pressure.

9. A micromachined capacitive microphone as in claim 8 in which the said diaphragm is anchored at one or more locations on the said support. Adjusting the number of anchoring positions, the said cantilever arm length, the support size and anchoring width of said anchors releases and controls the stress level in the said diaphragm.

10. A micromachined capacitive microphone as in claim 8 in which the said diaphragm has a plurality of support dimples that define the separation of the said diaphragm from the said perorated backplate.

11. A micromachined capacitive microphone as in claim 8 in which the said diaphragm having a plurality of support dimples rests freely on the said backplate and is simply supported on the said backplate by the said dimples.

12. A micromachined capacitive microphone as in claim 8 in which the said diaphragm is loosely supported by the said substrate at positions where the said diaphragm is not anchored onto the said support, and is bounded by the said edge rail and said tap for lateral and vertical movements.

13. A micromachined capacitive microphone as in claim 1 in which the said backplate is conductive, has one conductive region and one non-conductive region. The dimples of said diaphragm are rested on the conductive region, and non-conductive region.

14. A micromachined capacitive microphone as in claim 8 in which the said diaphragm is made of a conductive film material, a non-conductive film and a conductive metal as electrode, and a composite of conductive and non-conductive films.

15. A micromachined capacitive microphone including
a shallowly corrugated diaphragm having a plurality of support dimples connected to the diaphragm is anchored at one or more locations on the support;
a remaining diaphragm layer that is loose at other locations is bounded at perimeters by edge rail and tap for lateral and vertical movements and forms a passage at these locations with the tap on edge rail;
a perforated backplate having perforation holes and through holes is spaced in parallel below the diaphragm;
the said diaphragm having electrode patterning is made of non-conductive material, and a composite of conductive and non-conductive layers; and
the said backplate having electrode patterning when the said backplate has a conductive region and a non-conductive region.

16. A micromachined capacitive microphone as in claim 15 in which the said diaphragm is anchored at one or more locations on the said support. Adjusting the number of anchoring positions, the said cantilever arm length, the support size and anchoring width of said anchors releases and controls the stress level in the said diaphragm.

17. A micromachined capacitive microphone as in claim 15 in which the said diaphragm has a plurality of support dimples that define the separation of the said diaphragm from the said perorated backplate.

18. A micromachined capacitive microphone as in claim 15 in which the said diaphragm having a plurality of support dimples rests freely on the said backplate and is simply supported on the said backplate by the said dimples.

19. A micromachined capacitive microphone as in claim 15 in which the said diaphragm is loosely supported by the said substrate at positions where the said diaphragm is not anchored onto the said support, and is bounded by the said edge rail for lateral movement.

20. A micromachined capacitive microphone as in claim 1 in which the said backplate is conductive, has one conductive region and one non-conductive region. The dimples of said diaphragm are rested on the conductive region or non-conductive region.

21. A micromachined capacitive microphone as in claim 15 in which the said diaphragm is made of non-conductive material, and a composite of conductive and non-conductive layers. The electrode so carried by the said diaphragm is patterned to reduce parasitics.

22. A micromachined capacitive microphone as in claim 15 in which the said backplate has a conductive region and a non-conductive region. The conductive region of the said backplate is patterned to reduce parasitics.
